(19) United States
(12) Patent Application Publication
(10) Pub. No.: US 2015/0375278 A1
(43) Pub. Date: Dec. 31, 2015

(54) APPARATUSES, SYSTEMS, AND METHODS FOR CLEANING

(71) Applicant: ECOSERV TECHNOLOGIES, LLC, ABBEVILLE, LA (US)

(72) Inventor: Kenny DesOrmeaux, Abbeville, LA (US)

(73) Assignee: ECOSERV TECHNOLOGIES, LLC, Abbeville, LA (US)

(21) Appl. No.: 14/749,347

(22) Filed: Jun. 24, 2015

Related U.S. Application Data
(60) Provisional application No. 62/017,585, filed on Jun. 26, 2014.

(51) Int. Cl. B08B 9/28

(52) U.S. Cl. CPC B08B 9/28

(57) ABSTRACT

Embodiments of the present invention include systems, apparatuses, and methods for cleaning interiors of containers. Cleaning systems are provided having a frame, a table attached to the frame, a gantry system secured above the table and attached to the frame; and a cleaning attachment secured to the gantry system and including a cleaning tool. The cleaning attachment may be positionable using the gantry system to fit in an opening of a container placed on the table. The cleaning tool may be remotely operable. The table may be adjustable. The cleaning tool may include a high pressure water line with a gamma jet disposed at one end.

### CROSS-REFERENCE TO RELATED APPLICATIONS

This application claims the benefit of U.S. Provisional Patent Application No. 62/017,585, filed on Jun. 26, 2014, which is incorporated herein by reference.

### FIELD

The present invention relates to systems, apparatuses, and methods for the removal of materials from surfaces, and in particular though non-limiting embodiments, to systems, apparatuses, and methods for cleaning inner surfaces of tanks and cuttings boxes.

### BACKGROUND

Boreholes include oil and gas wells, water wells, and holes drilled for geotechnical investigation or exploration. During this drilling process, a drill bit may be advanced through solid materials within the boreholes and produce waste, including drill cuttings, mud, debris, chemicals, and wastewater. Drill cuttings are broken bits of the solid material removed from the borehole. The cuttings and/or other waste/debris are carried to the surface using a drilling fluid circulating up from the drill bit.

The drill cuttings and/or other waste are typically collected for treatment and disposal. For example, drill cuttings from an offshore operation may be placed in containers, such as cuttings boxes and/or tanks for transport to onshore locations for disposal and/or treatment. Usually, the containers, including the cuttings boxes and/or tanks are removed by a crane and the contents are dumped for disposal. The boxes and/or tanks often contain residual materials that need to be cleaned out.

The containers, including boxes and/or tanks, may be placed on a portable skid for cleaning and individual workers generally clean each container by hand. Cleaning may take thirty minutes or more to complete. In addition to worker time, there is risk associated with workers manually cleaning out the tanks and/or boxes, including exposure to the contents of the tanks and/or boxes.

Therefore, there is a long-felt, but unmet, need for improved systems, apparatuses, and methods for cleaning inner surfaces of containers, including tanks and/or cuttings boxes, which are more efficient, safe, and eliminate exposing workers to potentially hazardous materials.

### SUMMARY

In an embodiment of the present disclosure, a cleaning system is provided. The cleaning system has a frame, a table attached to the frame, a gantry system secured above the table and attached to the frame, and a cleaning attachment secured to the gantry system and having a cleaning tool. The cleaning attachment may be positionable using the gantry system to fit in an opening of a container placed on the table. The cleaning tool may be remotely operable. The frame may have a plurality of beams extending vertically from corners of a base. Safety walls may extend between lower portions of the plurality of beams. Safety walls may be configured to contain materials within the system during cleaning and prevent accidents. Safety bumper may extend from a front end of the base. Safety bumper may be configured to ensure that the container stays in place during cleaning. The table may be adjustable.

The system may further have a lifting system configured to lift the table or a portion thereof. The lifting system may have hydraulic cylinders located at a corner of that table. The hydraulic cylinders may be configured to lift the table such that any items or materials placed upon the table move to a single lowest point at a diagonally opposing corner of the table. The opposing corner of the table may pivot when the corner of the table is lifted and lowered. The table may pivot via a hinge mechanism. The hinge mechanism may have a hinge pin attached to a bottom portion of the frame and a hinge clamp enveloping the hinge pin. The hinge clamp may be attached to the opposing corner of the table such that the opposing corner of the table and attached hinge clamp pivot around the hinge pin when the corner of the table is lifted and lowered.

The gantry system may have elbow extensions extending from the plurality of beams or from a collar attached to the plurality of beams, a first horizontal member and second horizontal member disposed between pairs of the elbow extensions and perpendicular to the plurality of beams, a cross bar disposed between the first and second horizontal members, and a hoist attached to the cross bar at a first end and the cleaning attachment at a second end. The cross bar may be configured to move horizontally along the first and second horizontal members. The hoist may be configured to move horizontally along the cross bar.

The cleaning tool may have a high pressure water line having a gamma jet disposed at one end. The high pressure water line may be pre-formed into an L-shape prior to cleaning. The cleaning attachment may be hydraulic or pneumatic. The cleaning attachment may have an inverted trapezoid shape. The cleaning attachment may have a hollow interior configured to be filled with fluids to ensure stability during cleaning. The cleaning attachment may have openings in its top and bottom portions such that the cleaning tool is inserted into and through the cleaning attachment. The cleaning attachment may have a retaining mechanism configured to control the cleaning tool during cleaning. The retaining mechanism may have three rods vertically extending from the bottom portion and attaching to a substantially circular shape. The cleaning attachment may have swivel handles configured to manipulate and position the cleaning tool, and hydraulic dampers and hydraulic cylinders to operate and hydraulically lock the cleaning attachment in place on the container prior to cleaning.

In an embodiment of the present disclosure, a method for cleaning a container is provided. The method includes placing the container inside a cleaning system, cleaning an interior of the container using a cleaning tool, removing water and other materials from the interior of the container, and removing the container from the cleaning system. The cleaning system has a frame, a table attached to the frame, a gantry system secured above the table and attached to the frame, and a cleaning attachment secured to the gantry system and having a cleaning tool. The cleaning attachment may be positionable using the gantry system to fit in an opening of a container placed on the table. The cleaning tool may be remotely operable. The container may be a Marine Portable Tank (MPT) or cuttings box. The table may be adjustable.

The method further includes using a lifting system configured to lift the table or a portion thereof. The lifting system has hydraulic cylinders located at a corner of the table. The hydraulic cylinders may be configured to lift the table such that any items or materials placed upon the table move to a single lowest point at a diagonally opposing corner of the table. The water, materials, and items are removed using a vacuum system. The method includes lifting the table such that the water, materials, and items move to the single lowest point for removal using the vacuum system. The method includes pressure washing an outer surface of the container. The cleaning tool may include a high pressure water line having a gamma jet disposed at one end. The cleaning of the interior of the cleaning system may take approximately 6 minutes. The method includes lifting a top cover of the container to reveal an opening into the interior of the container, placing the cleaning attachment onto the container via the opening, and hydraulically locking the cleaning attachment in place via hydraulic dampers and hydraulic cylinders located on the cleaning attachment. The method includes covering open left and right sides of the opening with a covering material to prevent cleaning water and other materials from exiting the container during cleaning. The covering material may be a Hypalon® rubber material.

In an embodiment of the present disclosure, a system is provided. The system includes a cleaning system, a container placed within the cleaning system for cleaning, and a vacuum system attached to the container to remove cleaning water and other materials from the container after cleaning. The cleaning system has a frame, a table attached to the frame, a gantry system secured above the table and attached to the frame, and a cleaning attachment secured to the gantry system and having a cleaning tool. The cleaning attachment may be positionable using the gantry system to fit in an opening of a container placed on the table. The cleaning tool may be remotely operable. The system may further have a lifting system configured to lift the table or a portion thereof. The lifting system has hydraulic cylinders located at a corner of the table. The hydraulic cylinders may be configured to lift the table such that any items or materials placed upon the table move to a single lowest point at a diagonally opposing corner of the table. The cleaning tool may include a high pressure water line having a gamma jet disposed at one end.

### BRIEF DESCRIPTION OF THE DRAWINGS

FIG. 1 is an isometric view of a cleaning station, according to an exemplary embodiment of the present invention;

FIG. 2 is a top view of a table mounted within the cleaning station shown in FIG. 1;

FIG. 2A is an enlarged isometric view of a corner of the table shown in FIG. 2;

FIG. 2B is an enlarged side view of a corner of the table shown in FIG. 2;

FIG. 3 is a perspective view of a Marine Portable Tank (MPT);

FIG. 4 is a broken isometric view of the tank cleaning station shown in FIG. 1 with an MPT cleaning attachment, according to an exemplary embodiment of the present invention;

FIG. 5 is a bottom isometric view of the MPT attachment shown in FIG. 4;

FIG. 6 is an isometric view of a cuttings box;

FIG. 7 is a broken isometric view of the tank cleaning station shown in FIG. 1 with a cuttings box cleaning attachment, according to an exemplary embodiment of the present invention;

FIG. 8 is a bottom isometric view of the cuttings box attachment shown in FIG. 7;

FIG. 9 is a front isometric view of the cuttings box hoist shown in FIG. 7;

FIG. 10 is an isometric view of a cleaning station, according to an exemplary embodiment of the present invention.

### DETAILED DESCRIPTION

Like reference characters denote like parts in the several Figures.

Embodiments of the present invention include a cleaning station/system that may be used to clean containers, including tanks and/or boxes. Cleaning station/system provides for automated cleaning of inner surfaces of containers with shorter cleaning times than existing approaches. Cleaning system may include a frame, a table, and a gantry system. Frame may be configured such that containers may fit within the frame. Table may be configured to lift and/or tilt at an angle and may be connected to a single point vacuum system to remove materials from a corner of the system. Gantry system may attach at upper ends of the frame structure and be connected to a cleaning attachment. Cleaning attachment may include a cleaning tool and may be positionable using the gantry system to fit in an opening of a container placed on the table. Cleaning tool may be remotely operable. Cleaning tools may include high pressure water lines having gamma jets disposed at their ends. Gamma jets provide automated cleaning of containers within the cleaning station/system. In embodiments, a method for cleaning a container is provided that includes placing a container into a cleaning station, cleaning the container with high pressure fluids, and removing materials from the container and/or station using a vacuum system.

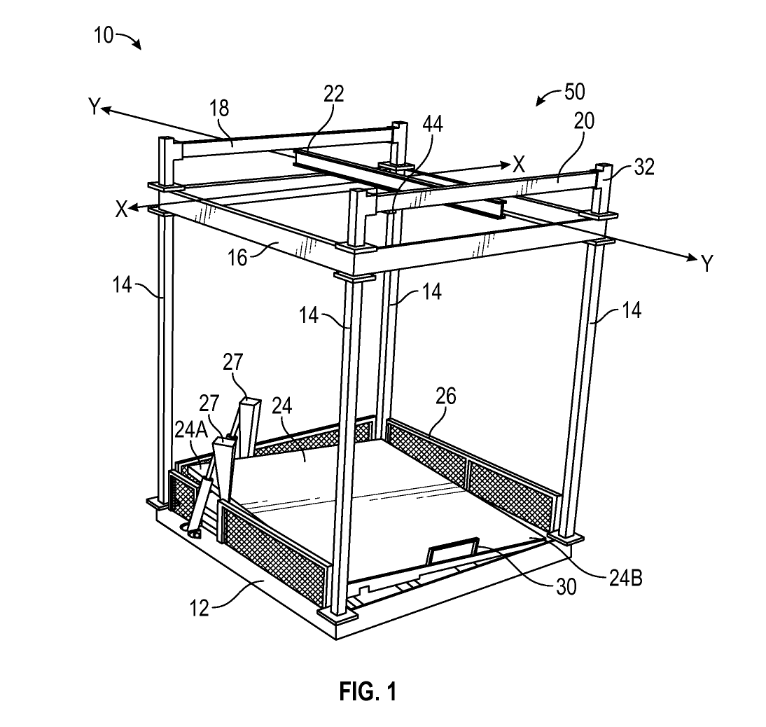

Referring to FIG. 1, a cleaning station/system 10 is shown. Cleaning station/system 10 includes a plurality of beams 14 extending vertically from base 12. Beams 14 are arranged such that they substantially form a square on base 12. Other configurations may be provided including dual stations in a substantially rectangular orientation. Plurality of beams 14 attach to base 12 at corners of base 12. Safety walls 26 extend between lower portions of beams 12. Safety walls 26 are configured to contain materials, including water, within the station 10 during cleaning and therefore prevent related accidents. In exemplary embodiments, safety walls 26 are made of metal. Safety bumper 30 extends from a front end of base 12 of station 10. Safety bumper 30 is configured to ensure that any container placed within station 10 stays in place during cleaning.

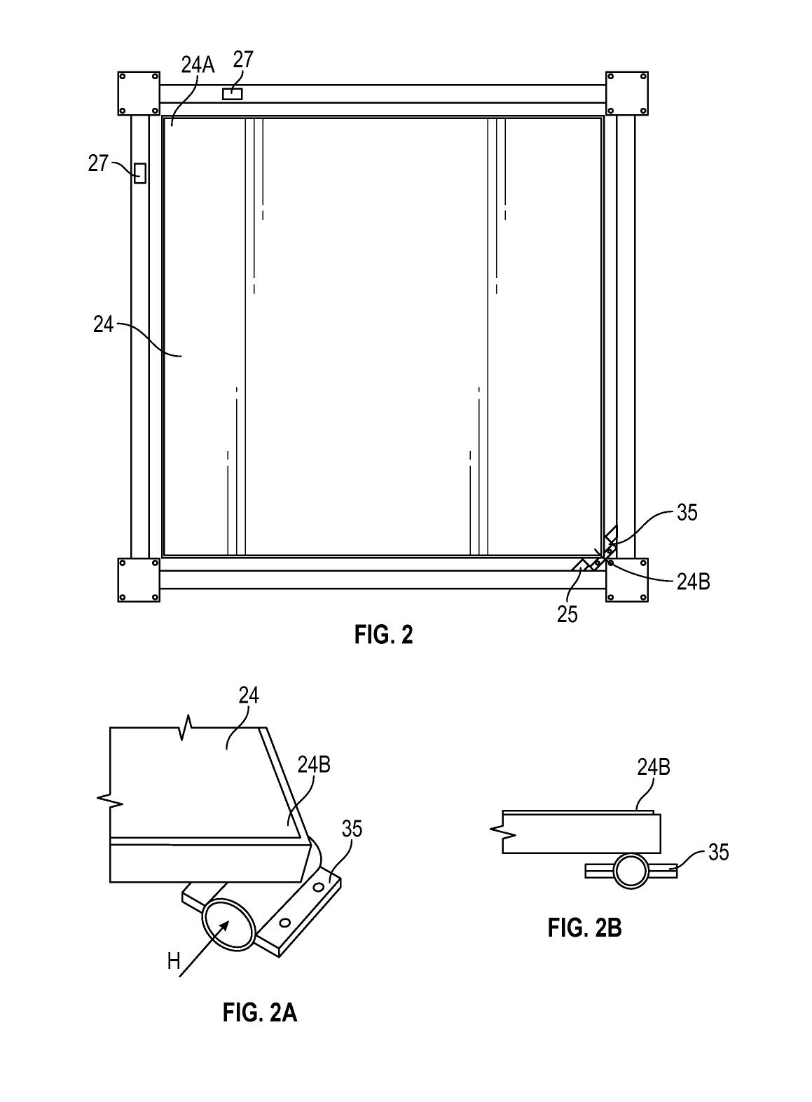

In embodiments of the present invention, table 24 is provided above base 12, and within the plurality of beams 14. FIG. 2 shows a top view of table 24 mounted within cleaning station/system 10. Table 24 is configured to be lifted and/or titled from a corner 24A such that any item placed upon table 24 may move to a single lowest point at a diagonally opposing corner 24B of table 24. FIGS. 2A and 2B show enlarged isometric and side views of corner 24B of table 24. Particularly, any materials and/or water from a container are immediately funneled to the lowest point for removal concurrent to, or after, cleaning of the container. Table 24 may have an adjustable mechanism configured to adjust/move table 24. In embodiments, table 24 may have a hydraulic lift configured to lift table 24. In exemplary embodiments, corner 24A of table 24 contains two hydraulic cylinders 27 to lift table 24. See, e.g., FIG. 1. In this embodiment, opposing corner 24B of table 24 is attached to a rod/hinge pin 25 such that table 24 may be lifted and/or lowered via a hinge/pivot mechanism. In exemplary embodiments, hinge pin 25 is an approximately 2.5 inch long solid steel bar welded to base 12 of cleaning station 10. See FIG. 2. The hinge mechanism includes top and bottom halves of a hinge clamp 35 bolted to each other around the hinge pin 25. See FIGS. 2A and 2B. FIGS. 2A and 2B depict this attachment without the hinge pin 35. As shown, the hinge pin 25 will be disposed within the hinge clamp 35 in opening, H. See FIG. 2A. The top half of the hinge clamp 35 is then welded to the table 24 and configured such that corner 24B of table 24 and attached hinge clamp 35 pivot around the hinge pin 25 via the hinge/pivot mechanism when the table 24 is lifted and/or lowered at corner 24A. See FIG. 2B. In other embodiments, table 24 may be attached to hinge pin 35 via any other attachment mechanism, including bolting. Table 24 may also be adjustable via any other mechanism and/or configuration. Although shown as being lifted from one particular corner 24A, table 24 may be adjusted from any other corner or portion of table 24 such that materials may be funneled to an opposing corner and/or side/portion. Further, table 24 may be lifted via any other lifting mechanism, including via cables attached to table 24. In yet other embodiments, table 24 may not have any lifting mechanism as disclosed herein.

In embodiments of the present invention, table 24 is combined with a vacuum system, which may be located at or near the single lowest point of table 24 when table 24 is lifted at the corner 24A. Vacuum system may be configured to remove materials and/or water from the single lowest point. Vacuum system may also be inserted directly into a container being cleaned and configured to remove waste and/or water from the container. Vacuum system may pull solid waste, including drill cuttings, from the container being cleaned into other containers and/or boxes near the station 10 for storing waste. Vacuum system may also pull liquid waste from the container being cleaned into other containers and/or tanks near the station 10 for additional storage and filtration.

Referring back to FIG. 1, a substantially square collar 16 is connected to beams 14 at upper ends of beams 14. Above collar 16, a gantry system 50 is attached. Gantry system 50 includes elbow extensions 32 attached at corners of collar 16. Alternatively, elbow extensions 32 may extend directly from beams 14. In embodiments, first horizontal member 18 and second horizontal member 20 are disposed between pairs of elbow extensions 32, perpendicular to beams 14 and parallel to base 12. Cross bar 22 may be connected to and disposed between first horizontal member 18 and second horizontal member 20. Cross bar 22 is configured to move horizontally along first horizontal member 18 and second horizontal member 20. As shown in FIG. 1, cross bar 22 is movable along the X-axis. Cross bar 22 may be movable via a track system or any other suitable system. Hoist 44 is connected to cross bar 22. Hoist 44 is configured to move along cross bar 22. As shown in FIG. 1, hoist 44 is movable along the Y-axis. Cleaning attachment 28 is attached to hoist 44. Cleaning attachment 28 is configured to fit in an opening of a container placed on the table 24, and manipulate an automated cleaning tool that is remotely operable. Cleaning tool may include a high pressure water line which may have a gamma jet disposed at one end. In exemplary embodiments, cleaning attachment 28 is a hydraulic cleaning attachment 28. Alternatively, cleaning attachment 28 may be pneumatic. Cleaning attachment 28 may be an MPT cleaning attachment 28A configured for use in Martine Portable Tanks (MPTs) and/or similar containers or tanks Cleaning attachment 28 may also be a cuttings box cleaning attachment 28B configured for use in cuttings boxes and/or similar containers or boxes. Cleaning station 10 is approximately 10′×10′×10′. However, cleaning station 10 may be any other size configured for insertion of containers of various sizes.

High pressure water lines are connected to cleaning attachment 28. High pressure water lines may include a jet at one end, which may be a gamma jet. Gamma jets are used to clean interiors of containers, including cuttings boxes and/or tanks, by insertion into openings on the containers. Utilizing high pressure lines and/or gamma jets within cleaning station/system 10 allows for interiors of containers to be cleaned without direct worker manipulation. Methods and apparatuses of using gamma jets to clean tanks and/or other containers are disclosed in U.S. Pat. Nos. 8,133,328 and 8,627,838, both of which are expressly incorporated herein by reference. The gamma jets clean the container utilizing a 360° spherical spray pattern/movement. In exemplary embodiments, high pressure lines and gamma jets are inserted into an opening of a container and used to clean the interior of the container in approximately 6 minutes, rather than approximately 30 minutes for typical manual cleaning. In embodiments, cleaning of station/system 10 using water lines and gamma jets may be performed via fully automated controls connected to station 10.

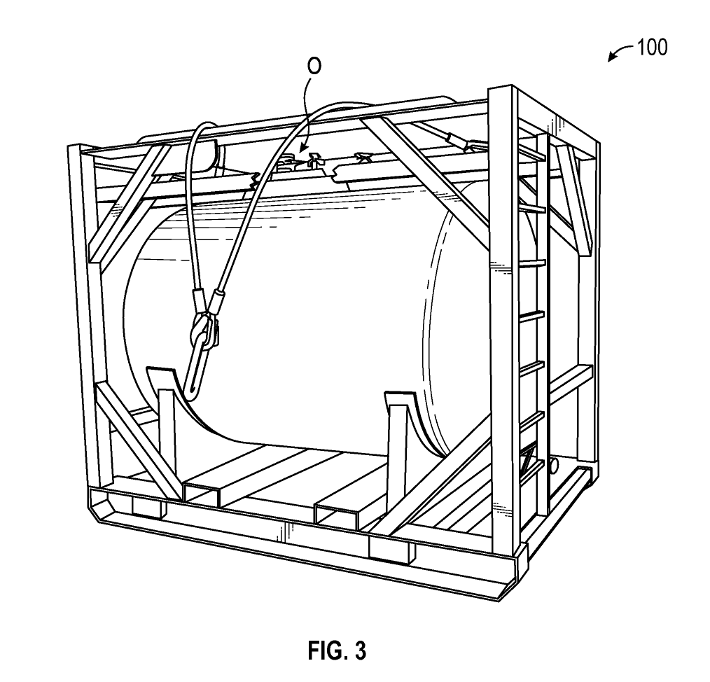

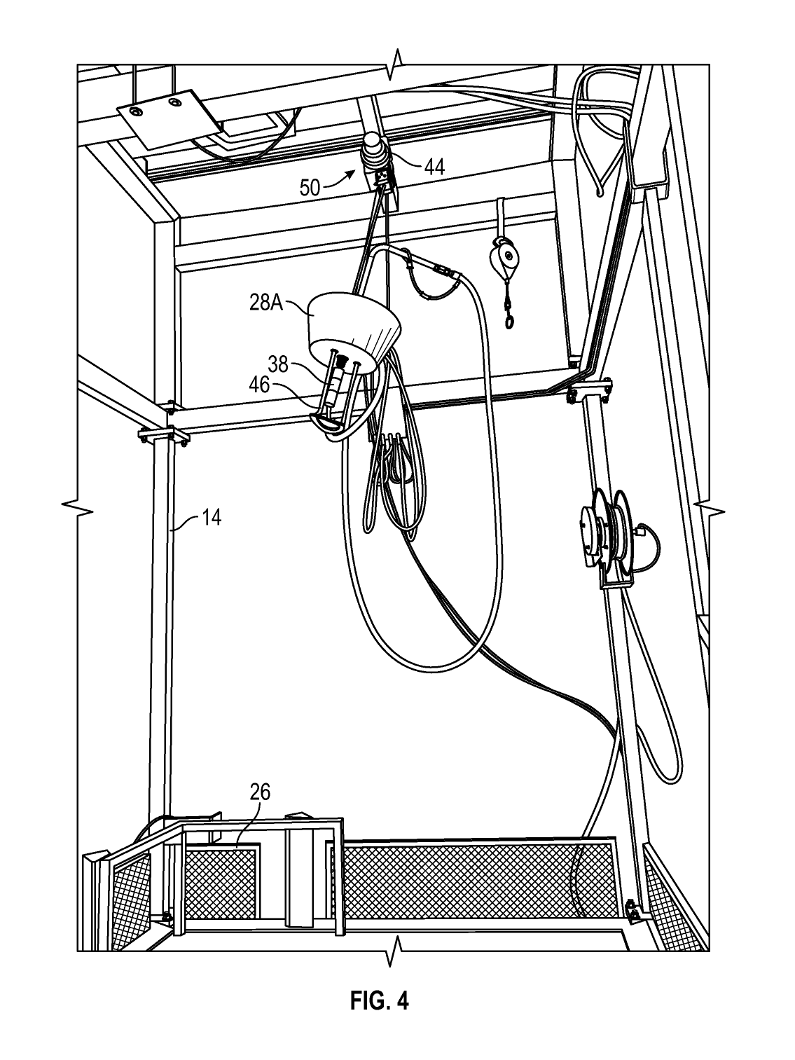

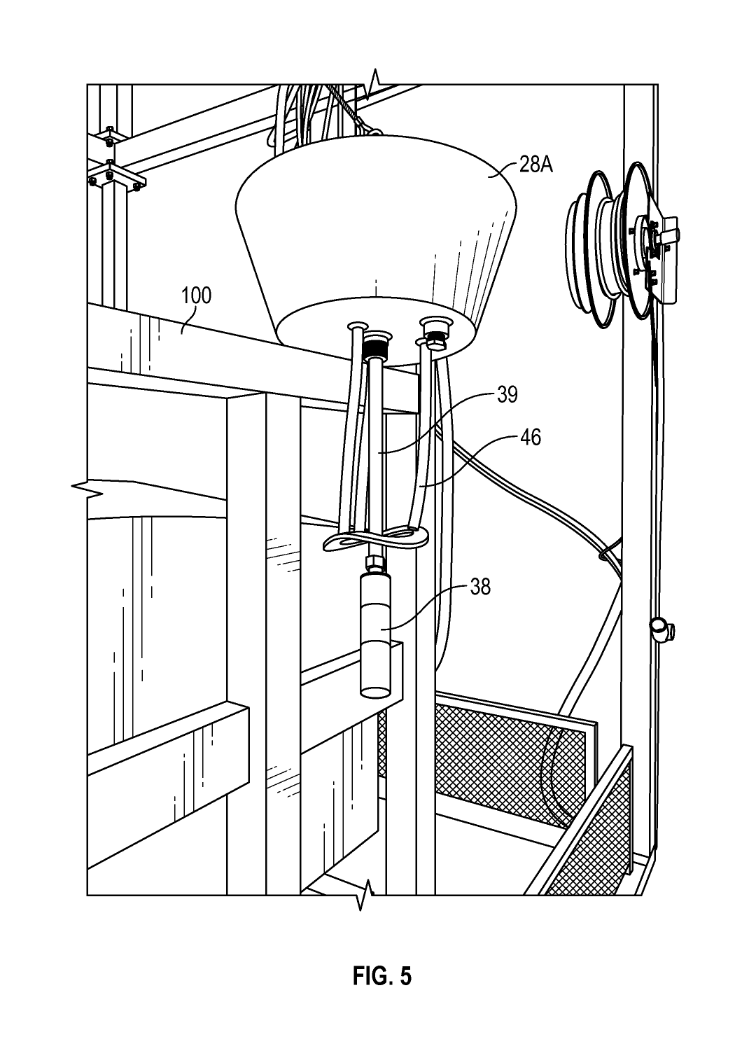

Referring to FIG. 3, a Marine Portable Tank (MPT) 100 is shown. FIG. 4 is a broken isometric view of cleaning station 10 with an MPT cleaning attachment 28A. FIG. 5 is an enlarged isometric view of MPT attachment 28A. As shown in FIGS. 3 and 4, cleaning attachment 28 is an MPT cleaning attachment 28A configured for use in MPTs and/or any other tank or container having an opening, O, at its top portion such that MPT cleaning attachment 28A may be inserted into the opening, O, for cleaning Opening, O, may be generally circular in shape or have any other shape suitable for insertion of MPT cleaning attachment 28A. MPT cleaning attachment 28A manipulates cleaning tools including high pressure water lines 39, having a gamma jet 38 disposed at one end. In other embodiments, any other cleaning tools may be used to clean interior of MPT 100. MPT cleaning attachment 28A has an inverted trapezoid or “bucket” shape suitable for insertion into and blocking of opening, O, prior to cleaning interior of MPT 100. See FIGS. 4 and 5. In other embodiments, MPT cleaning attachment 28A may have any other shape for insertion into openings of containers. In embodiments, MPT cleaning attachment 28A may be a solid piece that fits snugly onto opening, O, of MPT 100. In other embodiments, cleaning attachment 28A may have a hollow interior that may be filled with fluids to stabilize cleaning attachment 28A upon full insertion into and through interior of MPT 100, while performing cleaning functions within MPT 100 or other container using the water line 39 and attached gamma jet 38. MPT cleaning attachment 28A also has openings in its top and bottom portions such that a water line 39 and attached gamma jet 38 are inserted into and through MPT cleaning attachment 28A. See FIGS. 4 and 5. Due to the high pressure water line 39 being used, as well as the related rapid movement of the gamma jet 38 during cleaning, cleaning attachment 28A has a retaining mechanism 46 attached at its bottom portion and configured to control positioning of the gamma jet 38 during cleaning Retaining mechanism 46 includes three rods vertically extending from the bottom portion of cleaning attachment 28A and attaching to a substantially circular shape. See FIG. 5. In other embodiments, retaining mechanism 46 of cleaning attachment 28A may have any other configuration for controlling the movement of the gamma jet 38 during cleaning.

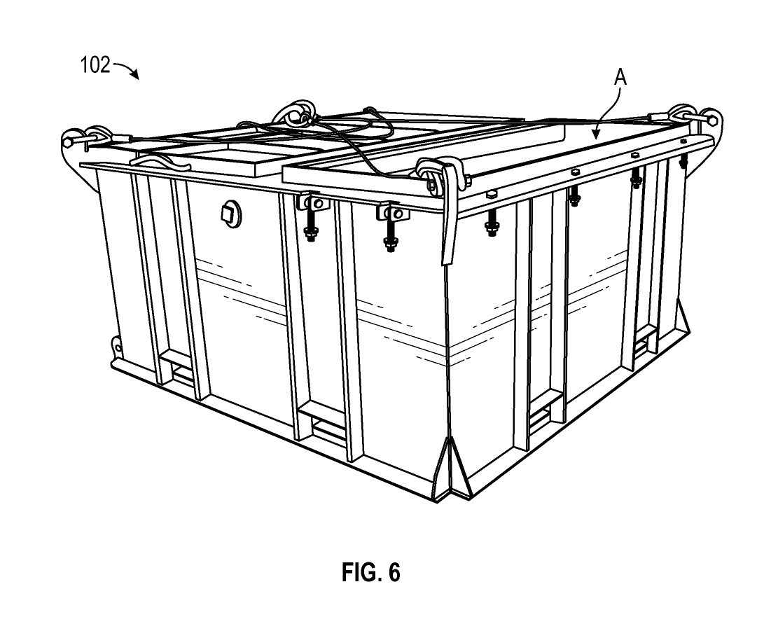

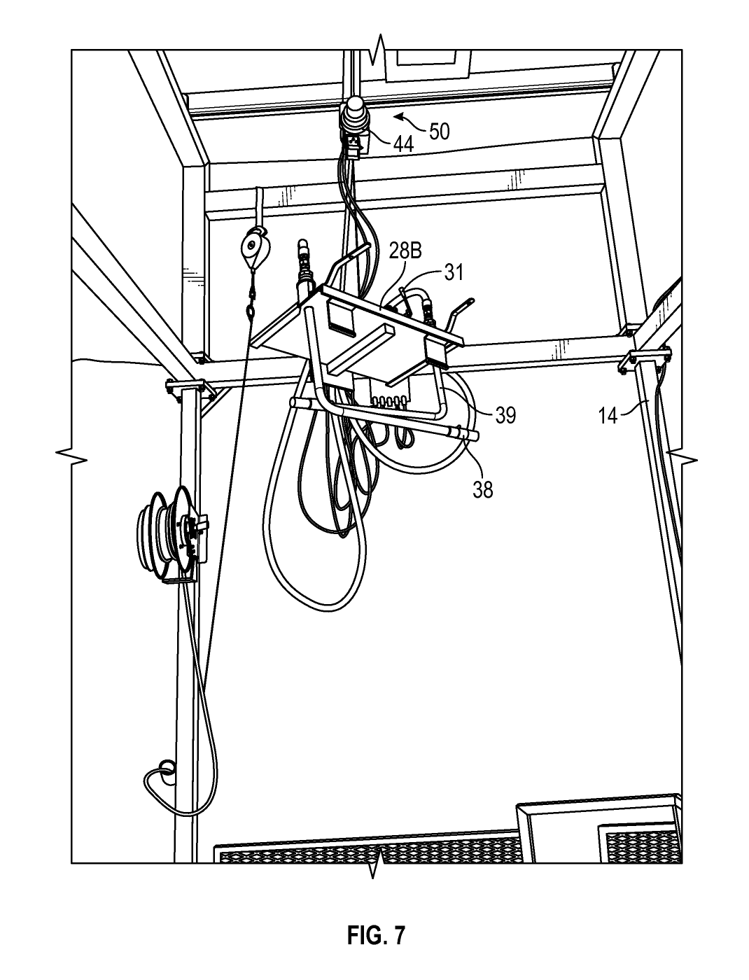

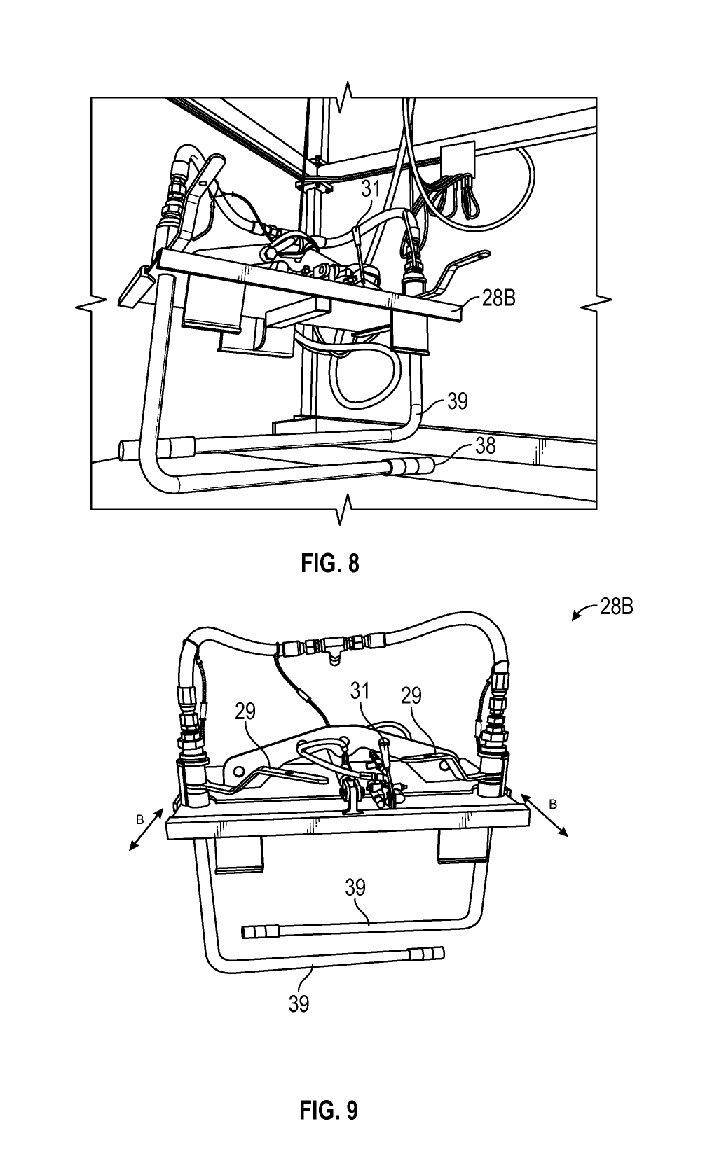

FIG. 6 shows a cuttings box 102. FIG. 7 is a broken isometric view of tank cleaning station 10 with a cuttings box cleaning attachment 28B. FIGS. 8 and 9 are different views of cuttings box cleaning attachment 28B. Typical cuttings boxes are less than 8 feet in any one direction, and cleaning station 10 may hold more than one cuttings box at a time. For example, cuttings boxes may be 85″×96″×39″ or 7′×6′×30″.

Cleaning attachment 28 as disclosed herein may be a cuttings box cleaning attachment 28B configured for use in cuttings boxes and/or any other container having an opening A at its top portion such that cuttings box cleaning attachment 28B may be inserted into the opening A for cleaning See FIGS. 6 to 9. Opening A may be generally rectangular in shape or have any other shape suitable for insertion of cuttings box cleaning attachment 28B. Cuttings box cleaning attachment 28B manipulates cleaning tools including high pressure water lines 39 having gamma jets 38 disposed at multiple ends. See FIGS. 8 and 9. In other embodiments, any other cleaning tools may be used to clean interior of cuttings box 102. Cuttings box cleaning attachment 28B includes two swivel handles 29 configured to manipulate and position high pressure water lines 39 having gamma jets 38 into place within the interior of cuttings box 102. In embodiments, high pressure water lines 39 are pre-formed into L-shapes that function to quickly and efficiently clean inner surface of cuttings box 102. However, the lines 39 may be formed into any other shape suitable to clean cuttings box 102. Cuttings box cleaning attachment 28B includes hydraulic dampers and/or hydraulic cylinders to operate and hydraulically lock cleaning attachment 28B in place on cuttings box 102 prior to cleaning Hydraulic dampers of cuttings box cleaning attachment 28B includes a damper handle 31 to open and close cleaning attachment 28B back and forth along direction B when placed upon opening A in cuttings box 102, and thereby lock cleaning attachment 28B into place on cuttings box 102. See FIG. 9; FIG. 6. This ability to customize/adjust the movement of cuttings box cleaning attachment 28B is important because it allows for its use in cuttings boxes 102, and openings A, having a variety of sizes and configurations.

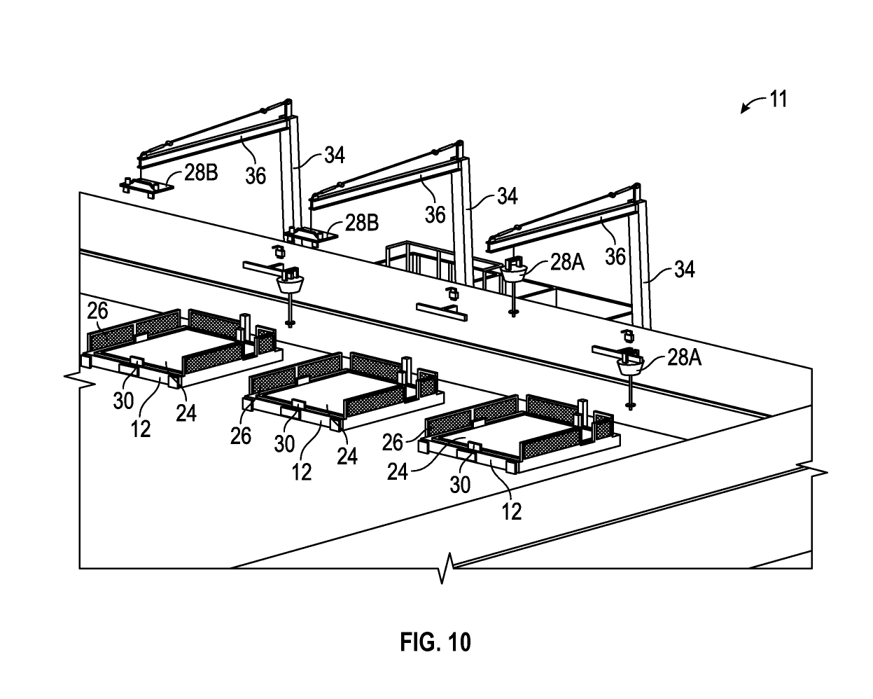

Referring to FIG. 10, a cleaning station/system 11 is shown. Cleaning station 11 includes several of the features of cleaning station 10 disclosed herein, including base 12, safety walls 26, table 24, safety bumper 30, hoist 44, cleaning attachment 28, vacuum system, high pressure water lines and/or gamma jets. Unlike cleaning station/system 10, however, cleaning station 11 does not include a plurality of beams extending from base 12, collar 16, elbow extensions 32, and/or first and second horizontal members 18, 20. Rather, cleaning station 11 performs these same functions via a gantry system that is not directly attached to the table 24. This gantry system includes a stand/beam 34 attached to and extending vertically from the ground or other surface. Beam 36 is connected to the top end of the stand/beam 34, parallel to base 12 and perpendicular to stand/beam 34. Cleaning attachment 28, including MPT cleaning attachment 28A and/or cuttings box cleaning attachment 28B, is attached to the beam 36. In embodiments, stand/beam 34 is placed behind a wall, with the other components of the cleaning station/system 11 placed adjacent to stand/beam 34 on the other side of the wall. Wall may be 6 feet high. Wall may contain support plates to hang equipment, including cleaning attachments 28 such as MPT cleaning attachment 28A and cuttings box cleaning attachment 28B. Wall may be a metal wall. Other embodiments may not include a wall, and stand/beam 34 may be placed immediately adjacent to cleaning station 11. Cleaning station/system 11 is approximately 12′×12′×12′ and configured to accommodate relatively larger containers/boxes/tanks than cleaning station/system 10. However, cleaning station 11 may be any other size configured for insertion of containers of various sizes.

In embodiments of the present invention, a method for cleaning a container, including an MPT 100 and cuttings box 102, is provided. The method includes using an adjustable gantry system 50 and cleaning attachment 28, as well as tilting table 24, all of which can be automated and operated remotely, thereby providing for fast and efficient cleaning of MPT 100 and/or cuttings box 102. The method includes placing the container, including the MPT 100 and/or cuttings box 102, to be cleaned inside a cleaning station/system 10, 11 described herein, cleaning inner surfaces of the containers, removing waste material from the containers, and removing the containers from cleaning station 10, 11. Cleaning stations/systems 10, 11 may include all the features described herein. The containers are automatically cleaned via high pressure water lines 39 having gamma jets 38, and the materials and cleaning water may be removed using a vacuum system. The vacuum system may be utilized concurrently with the cleaning process, or may be utilized after cleaning. The method further includes pressure washing the outer surface of the containers, either concurrently with the cleaning process, or after cleaning.

In embodiments of the present invention, a method for cleaning an MPT 100 is provided. The method includes placing the MPT 100 inside cleaning station/system 10, 11 described herein, cleaning inner surfaces of the MPT 100, removing waste material from the MPT 100, and removing the MPT 100 from cleaning station 10, 11. Cleaning stations/systems 10, 11 may include all the features described herein. Particularly, the method includes lifting a top cover of MPT 100 to reveal an opening, O, into interior of MPT 100, inserting MPT cleaning attachment 28A through the opening, and cleaning inner surface of the MPT 100 using a gamma jet 38 manipulated by MPT cleaning attachment 28A. The method further includes pressure washing the outer surface of the MPT 100, and removing materials and cleaning water via a vacuum system attached to MPT 100.

In embodiments of the present invention, a method for cleaning a cuttings box 102 is provided. The method includes placing the cuttings box 102 inside cleaning station/system 10, 11 described herein, cleaning inner surfaces of the cuttings box 102, removing waste material from the cuttings box 102, and removing the cuttings box 102 from cleaning station 10, 11. Cleaning stations/systems 10, 11 may include all the features described herein. Particularly, the method includes lifting a top cover of cuttings box 102 to reveal an opening A into interior of cuttings box 102, and placing cuttings box cleaning attachment 28B onto cuttings box 102 via opening A. The method includes hydraulically locking cleaning attachment 28B in place via hydraulic dampers and/or hydraulic cylinders located on cleaning attachment 28B. The method includes covering open left and right sides of opening A with a covering fabric, plastic, and/or other material to prevent cleaning water and/or other waste from exiting the cuttings box 102 during cleaning Doing so provides for reduced worker exposures to the contents being cleaned from cuttings box 102, which may be toxic and/or dangerous. In exemplary embodiments, a Hypalon® rubber material is used to cover the left and right sides of opening A. The Hypalon® fabric/material may have magnets at its ends to affix the material onto the box 102 during the cleaning process. The method includes cleaning inner surfaces of the cuttings box 102 using gamma jets 38 manipulated by cuttings box cleaning attachment 28B. The method further includes pressure washing the outer surface of the cuttings box 102, and removing materials and cleaning water via a vacuum system attached to cuttings box 102.

In embodiments of the present invention, a system for cleaning an interior of a container is provided. The system includes cleaning station/system 10, 11 described herein, a container placed within the cleaning station/system 10, 11 for cleaning, and a vacuum system attached to the container and/or system 10, 11 to remove waste materials and cleaning water from the container and/or system 10, 11. Cleaning stations/systems 10, 11 may include all the features described herein.

While the embodiments are described with reference to various implementations and exploitations, it will be understood that these embodiments are illustrative and that the scope of the inventions is not limited to them. Many variations, modifications, additions, and improvements are possible. Further still, any steps described herein may be carried out in any desired order, and any desired steps added or deleted.

What is claimed is:

1. A cleaning system, comprising:
a frame;
a table attached to the frame;
a gantry system secured above the table and attached to the frame; and
a cleaning attachment secured to the gantry system and including a cleaning tool,
wherein the cleaning attachment is positionable using the gantry system to fit in an opening of a container placed on the table,
wherein the cleaning tool is remotely operable.

2. The system of claim 1, wherein the frame includes a plurality of beams extending vertically from corners of a base.

3. The system of claim 2, further comprising safety walls extending between lower portions of the plurality of beams, the safety walls configured to contain materials within the system during cleaning and prevent accidents.

4. The system of claim 2, further comprising a safety bumper extending from a front end of the base, the safety bumper configured to ensure that the container stays in place during cleaning.

5. The system of claim 1, wherein the table is adjustable.

6. The system of claim 5, further comprising a lifting system configured to lift the table in a corner, wherein the lifting system includes hydraulic cylinders located at the corner and configured to lift the table such that material in the container moves to a single lowest point at a diagonally opposing corner of the table.

7. The system of claim 6, wherein the opposing corner of the table pivots when the corner of the table is lifted and lowered.

8. The system of claim 7, wherein the table pivots via a hinge mechanism, the hinge mechanism including a hinge pin attached to a bottom portion of the frame; and a hinge clamp enveloping the hinge pin, wherein the hinge clamp is attached to the opposing corner of the table such that the opposing corner of the table and attached hinge clamp pivot around the hinge pin when the corner of the table is lifted and lowered.

9. The system of claim 2, wherein the gantry system includes:
elbow extensions extending from the plurality of beams or from a collar attached to the plurality of beams;
a first horizontal member and second horizontal member disposed between pairs of the elbow extensions and perpendicular to the plurality of beams;
a cross bar disposed between the first and second horizontal members, the cross bar configured to move horizontally along the first and second horizontal members; and
a hoist attached to the cross bar at a first end and the cleaning attachment at a second end, wherein the hoist is configured to move horizontally along the cross bar.

10. The system of claim 1, wherein the cleaning tool includes a high pressure water line having a gamma jet disposed at one end.

11. The system of claim 1, wherein the cleaning attachment is hydraulic or pneumatic.

12. The system of claim 1, wherein the cleaning attachment has an inverted trapezoid shape.

13. The system of claim 12, wherein the cleaning attachment has a hollow interior configured to be filled with.

14. The system of claim 12, wherein the cleaning attachment has openings in its top and bottom portions such that the cleaning tool is inserted into and through the cleaning attachment.

15. The system of claim 14, wherein the cleaning attachment includes a retaining mechanism configured to control the cleaning tool during cleaning, the retaining mechanism including three rods vertically extending from the bottom portion and attaching to a substantially circular shape.

16. The system of claim 1, wherein the cleaning attachment includes:
swivel handles configured to manipulate and position the cleaning tool; and
hydraulic dampers and hydraulic cylinders to operate and hydraulically lock the cleaning attachment in place on the container prior to cleaning.

17. The system of claim 10, wherein the high pressure water line is pre-formed into an L-shape prior to cleaning.

18. A method for cleaning a container, comprising:
placing the container inside a cleaning system, the cleaning system including a frame; a table attached to the frame; a gantry system secured above the table and attached to the frame; and a cleaning attachment secured to the gantry system and including a cleaning tool, wherein the cleaning attachment is positionable using the gantry system to fit in an opening of a container placed on the table, wherein the cleaning tool is remotely operable;
cleaning an interior of the container using the cleaning tool;
removing water and other materials from the interior of the container; and
removing the container from the cleaning system.

19. The method of claim 18, wherein the container is a Marine Portable Tank (MPT) or cuttings box.

20. The method of claim 18, wherein the table is adjustable.

21. The method of claim 20, further comprising using a lifting system configured to lift the table in a corner, wherein the lifting system includes hydraulic cylinders located at the corner and configured to lift the table such that any items or materials placed upon the table move to a single lowest point at a diagonally opposing corner of the table.

22. The method of claim 21, wherein the water, materials, and items are removed using a vacuum system.

23. The method of claim 22, wherein the method includes lifting the table such that the water, materials, and items move to the single lowest point for removal using the vacuum system.

24. The method of claim 18, further comprising pressure washing an outer surface of the container.

25. The method of claim 18, wherein the cleaning tool includes a high pressure water line having a gamma jet disposed at one end.

26. The method of claim 25, wherein the cleaning of the interior of the cleaning system takes approximately 6 minutes.

27. The method of claim 18, wherein the method includes:
lifting a top cover of the container to reveal an opening into the interior of the container;
placing the cleaning attachment onto the container via the opening; and
hydraulically locking the cleaning attachment in place via hydraulic dampers and hydraulic cylinders located on the cleaning attachment.

28. The method of claim 27, further comprising covering open left and right sides of the opening with a covering material to prevent cleaning water and other materials from exiting the container during cleaning.

29. The method of claim 28, wherein the covering material is a Hypalon® rubber material.

30. A system, comprising:
a frame;
a remotely adjustable table attached to the frame;
a gantry system secured above the table;
a cleaning attachment secured to the gantry system and including a cleaning tool, wherein the cleaning attachment is positionable using the gantry system to fit in an opening of a container placed on the table, and substantially enclose the container; and
a vacuum assembly attached to the container configured to remove cleaning water and other materials from the container, wherein at least one of the gantry system, cleaning attachment and cleaning tool are remotely operable.

31. The system of claim 30, further comprising a lifting system configured to lift the table in a corner, wherein the lifting system includes hydraulic cylinders located at the corner and configured to lift the table such that any items or materials placed upon the table move to a single lowest point at a diagonally opposing corner of the table.

32. The system of claim 30, wherein the cleaning tool includes a high pressure water line having a gamma jet disposed at one end.

33. The system of claim 30, wherein the cleaning attachment includes baffles that are adjustable to substantially enclose different size opening of different containers.
